(19) United States
(12) Patent Application Publication
(10) Pub. No.: US 2003/0078990 A1
(43) Pub. Date: Apr. 24, 2003

(54) Remote control method for controlling electrical appliance via home gateway

(76) Inventor: Shing Young Lee, Taipei County (TW)

Correspondence Address: JACOBSON HOLMAN PLLC, 400 SEVENTH STREET N.W., SUITE 600, WASHINGTON, DC, 20004, US

(21) Appl. No.: 10/046,700

(22) Filed: Jan. 17, 2002

(30) Foreign Application Priority Data
Oct. 18, 2001 (TW) 090125834

(51) Int. Cl. G06F 15/173

(52) U.S. Cl. 709/218; 709/238

(57) ABSTRACT

A remote control method for controlling electrical appliance via a home gateway proceeds with an input signal by a telephone call to initiate the main board (the host) to connect to the INTERNET. After registering to the specific DNS server to have the pre-registered IP address, the user is able to control the initiation of household electrical appliances.

### BACKGROUND OF THE INVENTION

1. Field of the Invention

The present invention relates to a remote control method, and more particularly to a remote control method for controlling electrical appliance via a home gateway. The method proceeds with an input signal by a telephone call to initiate the main board (the host) to connect to the INTERNET. After registering to the specific DNS server to have the pre-registered IP address, the user is able to control the initiation of household electrical appliances.

2. Description of Related Art

Automation is currently the synonym of modernization. People try every possible means to make our life easy, simple and more convenient. One approach is to remote control the household electrical appliance. In the early phase, people try to control the appliance by inputting a code through a phone call. Pressing the buttons, digital signals are generated to control the initiation of the appliance. However, while controlling the appliance, the user has to memorize complicated combination of numbers or a series of numbers so as to proceed the control, which is quite complex for the user and not convenient. Recently, another approach is to proceed the control by means of the INTERNET, which includes two different types of control. The first one is similar to the previously conventional method and is accomplished by 56K modem accessing the main board. The second method is accomplished by ADSL broad band that provides a channel to communicate with the main board. The first method has limitations such as the speed of data transmission is low and a telephone line has to be provided during the entire communication. The second method mitigates the speed problem, however, the fixed IP connection tends to generate high controlling cost throughout the process.

To overcome the shortcomings, the present invention intends to provide an improved controlling method to mitigate or obviate the aforementioned problems.

### SUMMARY OF THE INVENTION

The primary objective of the invention is to provide a method to control the household electrical appliance through the gateway provided in individual house. The connection with the INTERNET is initiated only when a phone call is made to activate the home gateway so that the connection cost is maintained minimum as possible.

Another objective of the invention is to provide a home gateway that is able to function as a fax server so as to send/receive faxed data.

Still, another objective of the invention is to provide an improved controlling method to activate the household electrical appliance through the power wires indoors so that there is no need to extra installation of transmission media to carry the code to various appliances.

Other objects, advantages and novel features of the invention will become more apparent from the following detailed description when taken in conjunction with the accompanying drawings.

### BRIEF DESCRIPTION OF THE DRAWINGS

FIG. 1 is a systematic diagram showing the connection between the home gateway with electrical appliances;

FIG. 2 is a diagram showing the internal structure of the home gateway;

FIG. 3 is a schematic view showing the control of the home gateway to various electrical appliances;

FIG. 4 is a schematic view showing the control of the home gateway to various electrical appliances through the power lines;

FIG. 5 is a schematic view showing the signal transmission interface with the electrical appliances;

FIG. 6 is a schematic view showing the process of code transmission to control the electrical appliances; and

FIGS. 7 and 8 are applications of the control method through GSM and WAP cellular phone.

### DETAILED DESCRIPTION OF PREFERRED EMBODIMENT

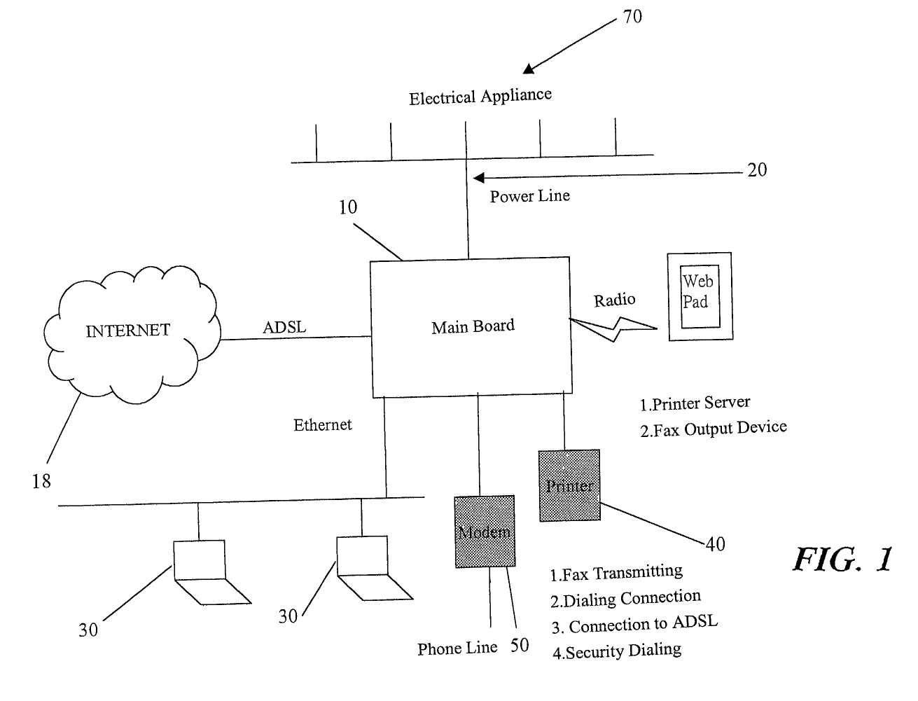

With reference to FIG. 1, the remote control method for controlling electrical appliances via home gateway has a main board (10). The main board (10) provides multiple personal computers (the number for PCs may be up to 253) (30) to access to the INTERNET by means of ADSL. Furthermore, the main board (10) is able to transmit the controlling code (data) to appliances through the power lines (20) so as to activate the appliances. The main board (10) is able to connect to a modem (50) connecting to the phone line so as to connect to a printer, such that the user is able to transmit or receive data through the modem (50).

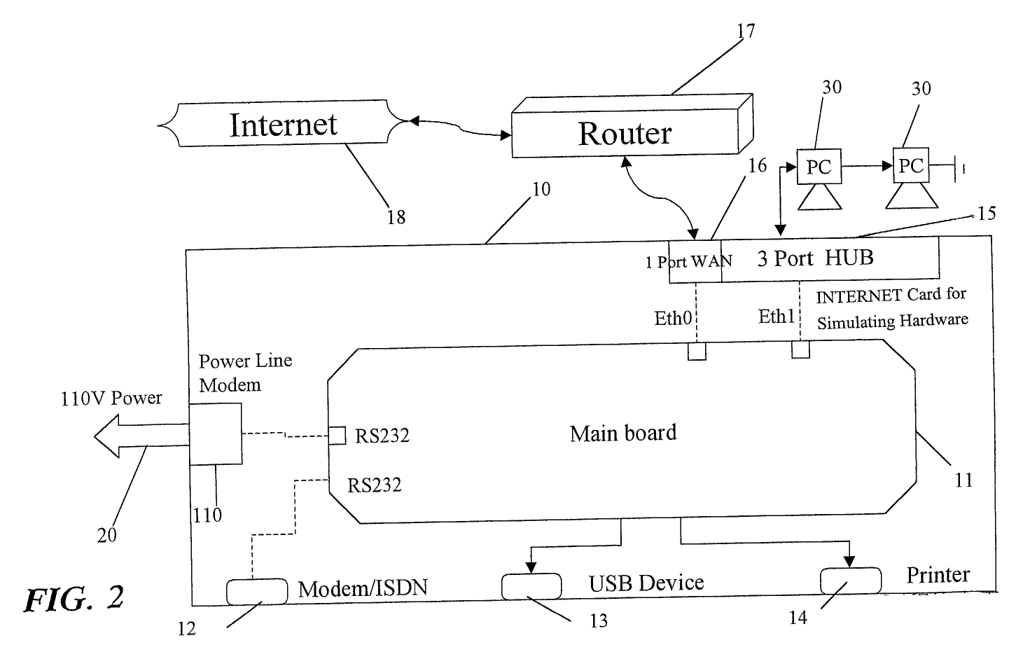

With reference to FIG. 2, the main board (10) has a controller (11) and two INTERNET ports, one is a WAN port (16) to connect to the INTERNET by way of a router (17) to connect to the INTERNET (18) and the other is a hub (15) to provide access to PCs to connect to the INTERNET (18). Two RS 232 ports are provided on the left side of the drawing, one is connected to a power line modem (110) to engage with the household electricity so that the controlling code is able to be carried away by the power line, the other RS 232 is a communication port to connect to a modem connecting port (12). Still, another printing port (14) is connected to a printer to provide a USB connecting port (13) to the USB device.

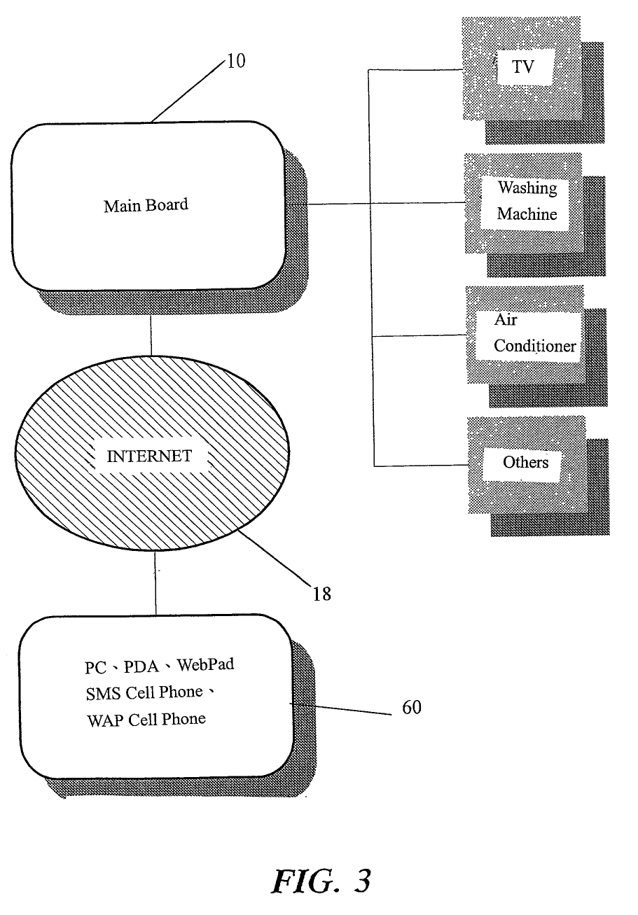

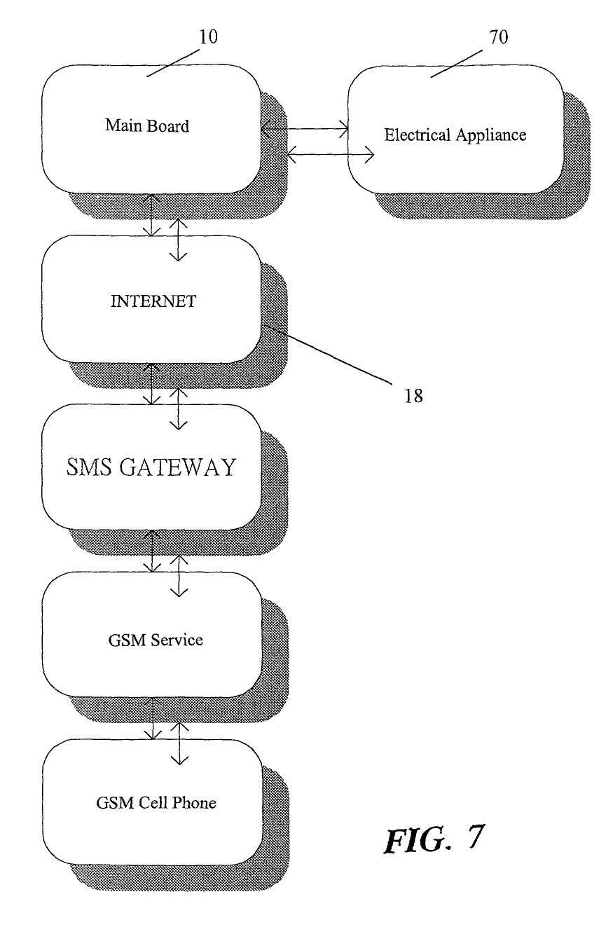

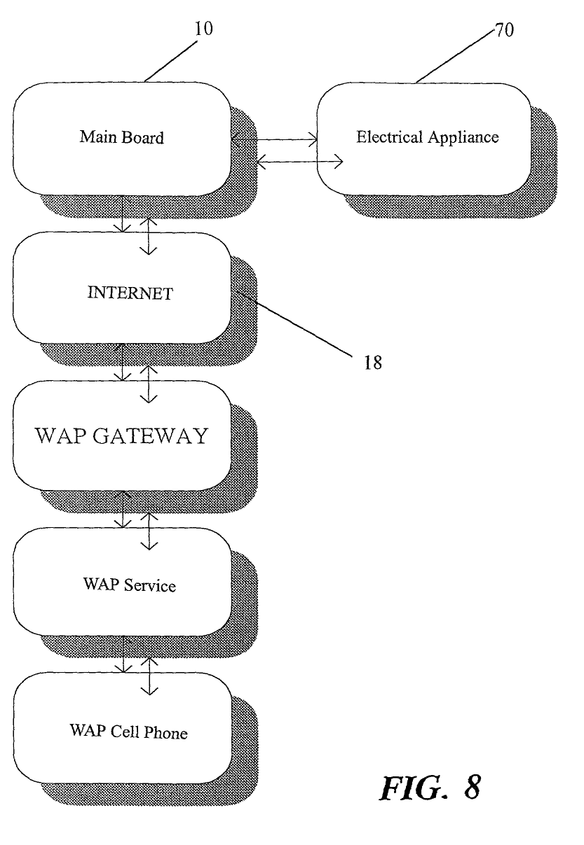

With reference to FIGS. 3 to 5, when the method is implemented, first the main board (10) is off-line with the INTERNET (18). When the user makes a call to the modem (50) and access the main board (10) through inputting a predetermined password, the main board (10) will automatically link the INTERNET (18) after the password is verified. When linking the INTERNET (18), the main board (10) will have to register to a specific DSN server to have a pre-registered IP address so that the main board (10) has the IP address available for outside connections. Then, the user is able to use an INTERNET accessible equipment (60), e.g. PC, PDA, Webpad, SMS mobile phone, WAP mobile phone etc., to retrieve the fontpage built in the IP address in the main board (10). The application is shown especially in FIGS. 7 and 8, which a GSM mobile phone, a WAP mobile phone or a GPRS mobile phone is able to have access to the INTERNET (18) through the GSM, WAP or GPRS server, so that the user is accessible to individual home gateway and thus controls the appliances.

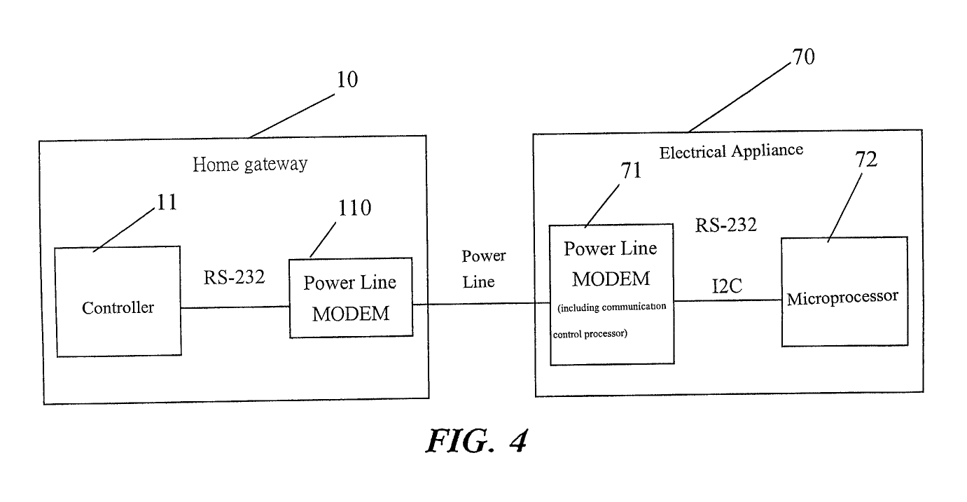

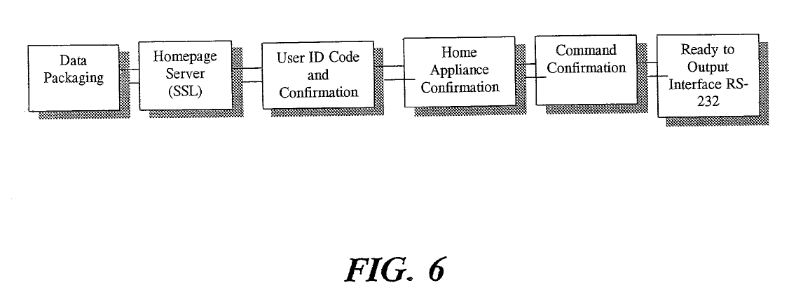

With reference to FIG. 6, the operation procedure of the method comprises the step of data wrapping (66). After the data is wrapped, the data enters a server (62), the main board (10), to proceed the user ID verification and password confirmation step (63). Then a step of electrical appliance confirmation is processed (64). When the subject is confirmed, a controlling code confirmation (65) is proceeded. After the controlling code is confirmed at the previous step, the controlling code is ready for transmission to the output interface, RS 232. As shown in FIG. 4, due to the existed power line in individual house, the controlling code is able to transmit to each of the electrical appliances through the aid of the modem (50) and by way of the power lines. Therefore, there is no need to have extra transmission media to transmit the controlling code, which is quite convenient to the user.

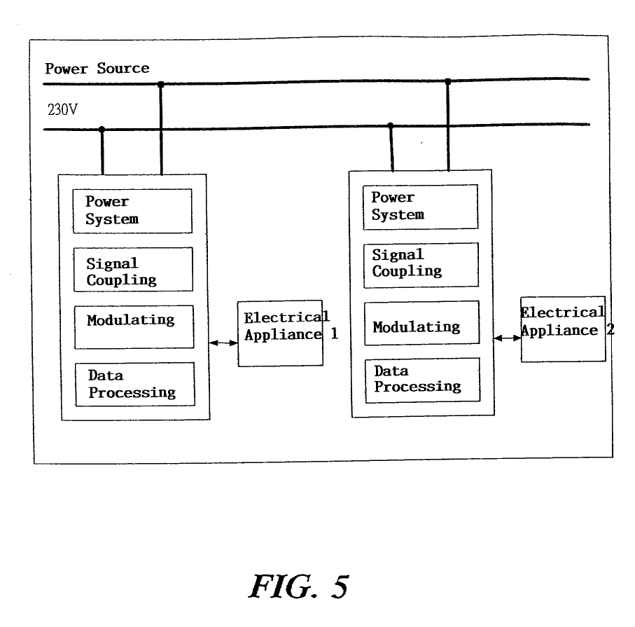

With reference to FIG. 5, the power line modem (110) in the main board (10) is able to transform the controlling code to a modem compatible language so that a similar power line modem (71) in the individual appliance (70) is able to communicate with the power line modem (110) in the main board (10). Thereafter, a microprocessor (73) is responsible to process the received signal from the modems (110,71).

With the foregoing method, the connection cost to the INTERNET is maintained minimum and the user only needs to memorize the password to access the main board (10) so that the method is a user friendly method and quite convenient in use.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A remote control method for controlling electrical appliances via home gateway comprising the act of:
preparing a main board to selectively connect to an INTERNET;
dialing a phone call to the main board to initiate the main board;
the main board connecting to the INTERNET;
acquiring a pre-registered IP address from a DNS server; and
using a tool accessible to the IP address for communicating with electrical appliances,
wherein a data confirmation step is added before the step of the main board connecting to the INTERNET so as to confirm the data input to the main board to initiate the main board.

2. The remote control method as claimed in claim 1, wherein the main board has a controller with two ports.

3. The remote control method as claimed in claim 2, wherein one of the ports is a hub.

4. The remote control method as claimed in claim 3, wherein the other one of the ports is a WAN port.

5. The remote control method as claimed in claim 1, wherein the main board further has a fax server so as to transmit and receive information.

6. The remote control method as claimed in claim 1, wherein the main board further has a modem connecting port.

7. The remote control method as claimed in claim 6, wherein the main board further has a modem connecting port.

8. The remote control method as claimed in claim 1, wherein the tool includes PC, PDA, GSM mobile phone, WAP mobile phone, GPRS phone or a Webpad.

9. The remote control method as claimed in claim 1, wherein the main board further has a power line modem.
